(19) United States
(12) Patent Application Publication
(10) Pub. No.: US 2011/0301994 A1
(43) Pub. Date: Dec. 8, 2011

(54) WIRELESS PUT-TO-LIGHT SYSTEM AND METHOD

(76) Inventor: James K. Tieman, Harrisonville, MO (US)

(21) Appl. No.: 13/154,215

(22) Filed: Jun. 6, 2011

Related U.S. Application Data
(60) Provisional application No. 61/351,997, filed on Jun. 7, 2010.

(51) Int. Cl. G06Q 10/00

(52) U.S. Cl. 705/7.15

(57) ABSTRACT

A wireless put-to-light order fulfillment system capable of being retrofitted and integrated into existing inventory management databases. In an exemplary embodiment, alert devices are placed on job order totes, and each alert device is associated with the host system's database software using an alert interface software. The lights on the job order totes inform pickers where to put the recently picked inventory item, reducing job errors and increasing picking efficiency.

This application claims priority in U.S. Provisional Patent Application No. 61/351,997, filed Jun. 7, 2010, which is incorporated herein by reference.

### BACKGROUND OF THE INVENTION

1. Field of the Invention

The present invention relates generally to a system and method for adding a wireless put-to-light directional system to an existing system for picking items from a warehouse, or other similar activity, and the practice of a method of such.

2. Description of the Related Art

Typical picking systems and methods seek to become more efficient by optimizing the number of picks that can be made in a certain period of time, while limiting the number of errors when making those picks. This leads to a maximum level of efficiency that can exist without improving the picking system itself. There are physical limits to the efficiency that can exist; a human picker can only handle a small number of different jobs at one time, and can only move so fast along rows of inventory.

Order picking in a warehouse varies depending on the function of the warehouse, be it a receiving function or a sending function. Some variations of order picking include picker-to-part, part-to-picker, sorting system, and pick-to-box. In many order picking operations, a picker is assigned tasks or job orders that need to be filled. Often the picker will carry along totes associated with each different job order, and a hand-held scanner or other device that tells the picker where to go and how many of each item to pick up to fill each job.

Problems can arise when the picker is assigned more totes than he or she can keep track of. If the picker is making errors when picking to fill orders, the system is less efficient than it could be if the picker was assigned fewer totes that he or she could keep track of. However; assigning fewer job orders to a picker at a time also lowers efficiency, because fewer jobs can be filled in the same amount of time.

In order to increase efficiency, alert systems can be used which allow a picker to fill more job orders at a time. For example, in a pick-to-light system, an operator will scan a bar-coded label attached to a box. A digital display located in front of the pick bin will inform the operator of the item and quantity that they need to pick. Companies typically use pick-to-light systems for their top selling products. Another example is a voice picking system, which informs the operator of pick instructions through a headset. The pick instructions are sent via RF from the company's ERP or order management software. The system allows operators to perform pick operations without looking at a computer screen or deal with paper pick-tickets. Many world class warehouse operations have adopted voice picking to complement the pick-to-light systems in place for their fast moving products. By introducing such systems, companies can gain significant efficiencies as it is totally paperless and eliminates the errors caused by pick tickets.

The problem associated with introducing a new, more efficient picking system is the cost associated with implementing the new system. If a warehouse wants to update their picking system to a pick-to-light or voice picking system, it will require completely replacing their current picking system. This includes replacement of software and re-entering of inventory data associated with the warehouse inventory. It will also require placing a light on each inventory storage bin, which can result in thousands or tens-of-thousands of lights. This can be expensive for a smaller warehouse where a pick-to-light system could in effect double productivity.

### SUMMARY OF THE INVENTION

It is an object of the present invention to provide a wireless put-to-light order fulfillment system that can be retrofitted and integrated into existing inventory management databases. In an exemplary embodiment, alert devices are placed on job order totes, and each alert device is associated with the host system's database software using an alert interface software. The lights on the job order totes inform pickers where to put the recently picked inventory item, reducing job errors and increasing picking efficiency.

### BRIEF DESCRIPTION OF THE DRAWINGS

In the accompanying drawings, which illustrate the principles of the present invention and an exemplary embodiment thereof:

FIG. 1 is a block diagram showing the relationships between the several components of a preferred embodiment of the present invention.

FIG. 2A is a plan view demonstrating an example of an alert device including display and bar code.

FIG. 2B is an isometric view showing the alert device in use with a number of job order totes on a cart and a picked item being placed into the tote associated with the active alert device.

FIG. 3 is an example of the interface database software used in the preferred embodiment of the present invention.

FIG. 4A is a flow chart demonstrating the practice of a method of a preferred embodiment of the present invention.

FIG. 4B is a flow chart demonstrating the practice of a method of a preferred embodiment of the present invention, continuing from FIG. 4A.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

The included embodiments of the present invention are typically mentioned with reference to a wireless put-to-light inventory picking and job order filling system, and a method of performing the same. The preferred embodiment of the present invention is able to be retrofitted into an existing picking and job order filling system in order to increase job performance speed while removing picker error.

### II. Embodiment of a Teaching System and Method 2

Generally, the present embodiment is a wireless put-to-light system 2 used to supplement an existing job order fulfillment system in a warehouse or other suitable location. A typical use of the preferred embodiment of the present invention would occur in a warehouse using host software 32 on its local computer or server system 24 in order to facilitate item picking in order to fulfill job orders. The job orders themselves are associated job order totes 5 tagged with a bar code I.D. 18, where the picker will place picked items 38 at the direction of an RF gun 34 including a bar code scanner.

The item picking system used by the host software includes a means of directing the picker where to pick up the next item and how much of that item needs to be picked up. This feature may be incorporated into the RF gun 34 carried by all pickers and used to identify picked products, or it may be a separate feature such as a voice command via wireless headset.

The put-to-light system 2 includes an alert device 4, interface software 30, and a paging transmitter 20. The put-to-light system 2 is implemented into the host system in order to improve job efficiency and reduce picker error by effectively alerting the picker to the correct job tote 5 associated with the picked item 38.

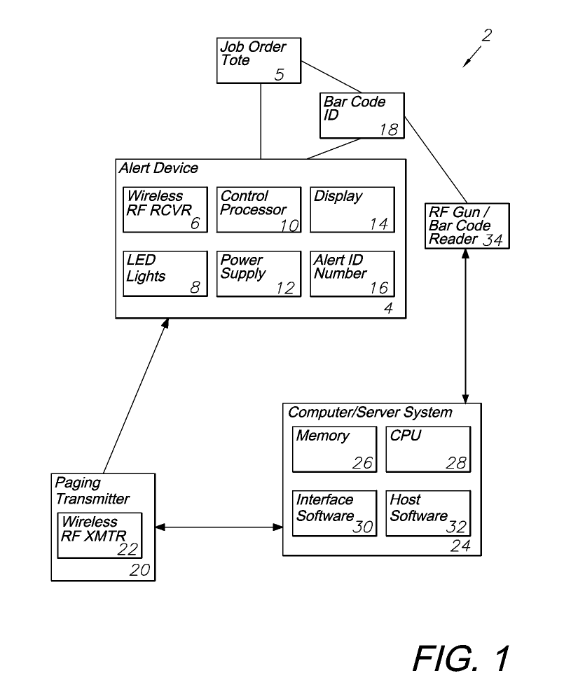

FIG. 1 shows the relationship between the various components of the integrated put-to-light job fulfillment system 2. The alert device 4 is further comprised of a wireless radio frequency (RF) receiver 6, a control processor 10, a power supply 12 and an alert ID number 16. The device 4 is also optionally equipped with LED lights 8, a display 14, and other optional alert elements such as a “rumble element” capable of vibrating the entire alert device 4, or a speaker capable of producing audio alerts. In the preferred embodiment, the alert device 4 will activate the LED lights 8, indicating the appropriate job tote 5 to be filled. The display 14 may include a physical identification of the alert ID number 16 or other important information.

A paging transmitter 20 including a wireless RF transmitter 22 communicates with the wireless RF receiver 6 located in the alert device 4. The paging transmitter 20 is connected to the computer or server system 24. The computer 24 will indicate which alert ID should be active, and the transmitter will transmit this information wireless to the appropriate alert device 4, which will then activate its LED lights 8 to identify where to place the next picked item.

The alert device will also be affixed with a bar code containing a bar code ID number 18. This bar code ID 18 is associated with a job number in the host system's software 32. The interface software 30 cross references the bar code ID 18 and associates the affixed alert device's ID number 16 with the appropriate bar code ID. Thus, if the lights 8 of the alert device 4 fail to trigger properly, the picker can manually confirm the correct job tote 5 by scanning the bar code ID 18 on the job totes 8 to find the correct tote.

The picker uses an RF gun 34 with a bar code reader and a display. This RF gun 34 provides direction and item quantity information to the picker, leading them to the correct location in the warehouse to pick up the next item. The RF gun 34 also allows the picker to confirm that the item has been picked up and placed into the proper job tote 5. The picker will scan the bar code ID of the item at the pick up site, place the item into the job tote 5 affixed with the active alert device 4.1, and scan the bar code ID 18 affixed to the active alert device 4.1 in order to communicate with the interface software 30 and host software 32 that the correct job item is in the correct tote, and the next item for picking will be queued up for the picker to obtain.

The computer or server system 24 includes a memory 26 and a CPU 28 and other necessary hardware and software, such as an operating system and display device. The preferred embodiment of the present invention includes both host software 32 and interface software 30. The host software 32 includes references to the bar code IDs 18 for all inventory and job totes 5. The host software 32 is typically stored in a database on the server. The interface software 30 is added to the server or computer and includes the alert ID numbers 16. The interface software 30 associates the alert IDs with bar code IDs located in the host software database. Once this association is made, any information called up by the host software regarding an identified bar code ID will be mirrored in the interface software. The computer 24 will instruct the RF transmitter 20 to activate the appropriate alert device 4 according to the alert ID number 16. This instructs the picker where to place the next pickup item.

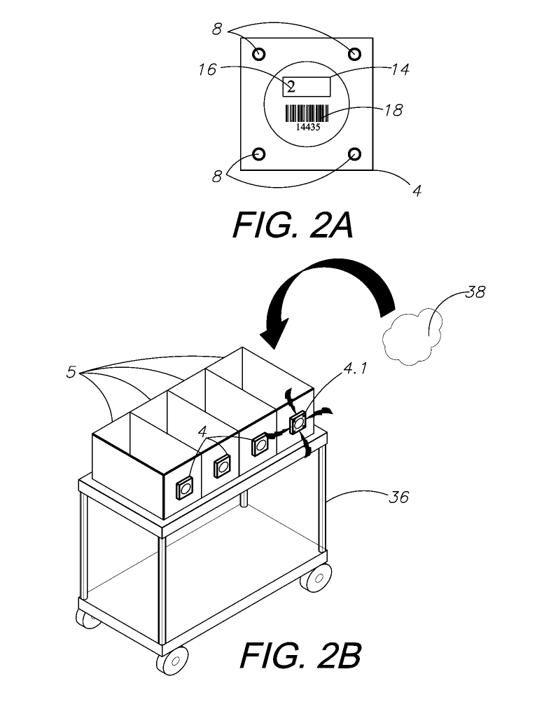

FIG. 2A shows an example embodiment of the alert device 4. The bar code and associated bar code ID 18 are affixed directly under the display 14, which actively displays the alert ID number 16. The LED lights 8 are located at the edges of the alert device 4. The lights may be on the surface of the alert device, or the alert device may be manufactured from a transparent or semi-transparent material and the lights installed within the device. The device must be of sufficient size to be affixed to a job order tote 5, while providing enough of an alert that a picker instantly determines which job tote is the correct tote.

FIG. 2B shows an example of a picker cart 36 include a number of job order totes 5. Each tote is affixed with an alert device 4. The picked item 38 is removed from the shelf as directed and placed into the job tote 5 containing the active alert device 4.1 Upon placing the item into the tote, the picker will scan the associated bar code ID 18 located on the active alert device 4.1 using the RF gun 34. The picker will either receive confirmation that the correct tote 5 has been filled, and the system will update; or the picker will receive an error message indicating that the item 38 was placed into the incorrect tote 5, and the picker will manually remove the item and place it into the appropriate tote.

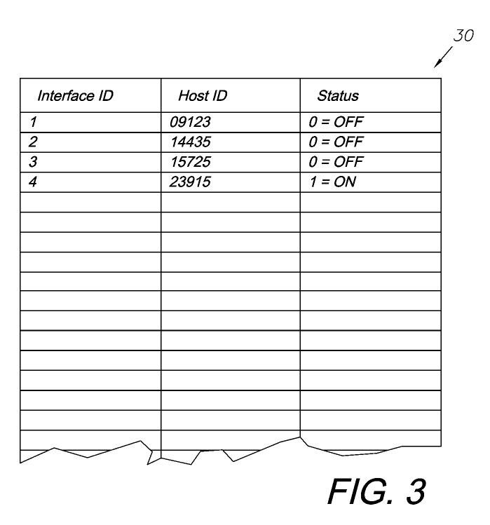

FIG. 3 shows an example of the interface software 30 as it would be displayed on a computer display. The software contains three important pieces of information: the Interface ID number, which is identical to the alert ID number 16; the Host ID number, which is identical to the bar code ID 18; and the status of the alert device. The status may include such options as “on,” “off,” “glow,” or “warn.” Each status may refer to a different light pattern or alert function installed in the alert device.

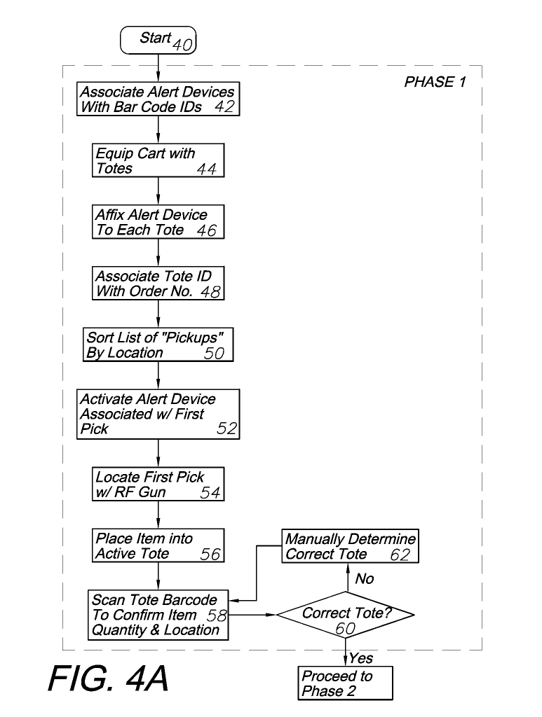

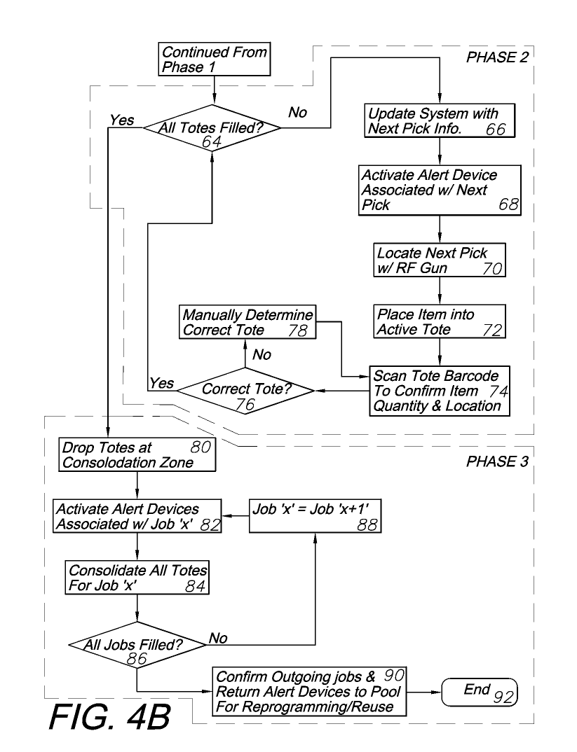

FIGS. 4A and 4B are a flow chart diagramming the practice of a method of the present invention. The method is essentially broken down into three separate phases.

FIG. 4A contains phase 1, which starts at 40. The alert devices are associated with the main bar code IDs at 42. The picker's cart is equipped with totes at 44. An alert device is affixed to each tote at 46. Each tote is then associated with a job order number at 48, which is tracked using the computer host software. The list of item “pickups” assigned to a picker are sorted by location at 50. The interface software identifies the bar code ID of the first item to be picked according to the determined location, and cross references this ID to determine the appropriate alert ID number. The first alert device is activated at 52, sending the picker off to fill the orders.

The picker uses the RF gun to locate the first pick at 54. This may be done by providing the picker with row or aisle information, shelf number, and/or coordinate information. Once the picker reaches the item, they will scan the bar code associated with the item to indicate they've located it, and place the item into the active tote at 56. The RF gun wirelessly communicates with the host software, which is now aware that the item has been picked. The picker will then scan the active alert device's bar code at 58. This scan is checked by the computer system, which determines whether the correct tote was scanned at 60. If not, the picker will manually determine what went wrong and place the correct item into the correct tote at 62.

FIG. 4B includes phases 2 and 3. Once the first item is picked and placed into the appropriate tote, the system will determine whether all job orders have been filled at 64. If not, the system will update with the next pick information at 66, and activate the appropriate next alert device at 68. The picker will locate the next pick using the RF gun at 70. Again, the picker will scan the item ID, place the item into the correct ID at 72, and scan the tote barcode at 74 to determine if the correct tote has been filled. The system will check whether the correct item was placed into the correct tote at 76, and if not, the user must manually determine the correct tote at 78.

Once all totes have been filled according to the current job assignment, phase 3 begins. The picker will drop the totes off at a consolidation zone at 80. Each job order may include a number of different totes, which is why the totes were associated with a particular job ID early in the process. A worker at the consolidation zone will activate all totes associated with job ‘x’ at 82, wherein ‘x’ is a job number. The alert devices affixed to the totes associated with job ‘x’ will light up, allowing the worker to consolidate these totes at 84. These totes will be loaded onto a single pallet for shipping.

A check is determined to see if all jobs have been filled at 86. If not, ‘x’ is updated to ‘x+1’ at 88, so that the next job is activated at 82, and consolidated at 84. This loop continues until all jobs are filled. The worker will then confirm all outgoing jobs at 90. The alert devices will be removed from their associated totes and returned to the device pool for reprogramming and reuse with other jobs. The method ends at 92.

### III. Advantages over Prior Art and Conclusion

The present invention provides many advantages over the prior art. By providing alert devices onto the job totes and activating the tote where the next picked item should be placed, the picker can take more totes at a time which will increase the speed at which jobs are filled. Also, the use of the alert device will lead to fewer mistakes being made by pickers inadvertently placing a picked item into an incorrect tote.

The present invention also leads to an easier method for consolidation, especially when job orders are large and formed from a number of different totes. Lighting up all totes associated with a single job in a consolidation zone makes it faster and easier to collect all totes for a particular job and send them off for shipment.

It is important to note that physical limitations place constraints on how efficient a warehouse picking and order filling system can be. An optimal number of pickers can be reached before the warehouse is too full, the pickers can only reach an optimal speed before they are traveling too fast for safety reasons, and the pickers can only realistically carry a limited number of job totes with them at a time before they become confused. The present system helps to improve efficiency where there is room for improvement without overloading other areas of warehouse management and optimization.

It is to be understood that while certain aspects of the disclosed subject matter have been shown and described, the disclosed subject matter is not limited thereto and encompasses various other embodiments and aspects. The above-mentioned steps and components are not meant to limit the use or organization of the present invention. The steps for performing the method may be performed in any logical method and in any logical order.

Having this described the invention, what is claimed as new and desired to be secured by Letters Patent is:

1. A method of filling job orders including a local computer system with host software, a CPU, and storage memory, a known inventory comprising a plurality of unique items identified by inventory I.D. numbers, and a plurality of inventory pickers, the method comprising the steps:
providing a plurality of storage totes capable of receiving and storing inventory items;
providing each said inventory picker an RF gun including a bar code reader, said RF gun capable of identifying picked inventory;
providing identification software capable of interfacing with computer system host software;
providing a wireless RF transmitter capable of transmitting notifications from said computer system to said RF guns;
placing a bar code comprising a tote I.D. number on each of said plurality of totes;
affixing an alert device onto each of said plurality of storage totes, said alert devices comprising an RF receiver, a control processor, a power supply, and an alert I.D. number;
creating a job order from a list of stored inventory I.D. numbers;
associating said tote I.D. numbers with said inventory I.D. numbers contained in said job order with said identification software and said host software;
associating said alert I.D. numbers with said tote I.D. numbers with said identification software and said host software;
sorting said job order inventory I.D. numbers by location;
instructing an inventory picker to the location of inventory to be picked via the computer system host software;
instructing an inventory picker to store the picked inventory item into the appropriate storage tote;
confirming that the proper inventory item has been picked up and placed into the proper storage tote by scanning said picked inventory item and said storage tote with said RF gun; and
wirelessly transmitting the confirmation to said computer system via said RF gun transmitter.

2. The method of claim 1, including the steps:
creating a database capable of being stored on the computer system memory, said database containing the bar code numbers of said unique inventory items, the tote I.D. numbers of said storage totes, and the alert I.D. numbers of said alert devices; and
creating said job order said database.

3. The method of claim 1, including the step:
providing notification to said plurality of inventory pickers by wirelessly communicating said notification from said computer system to said RF gun.

4. The method of claim 1, including the steps:
providing each said inventory picker with a wireless headset capable of receiving wireless voice communications; and
providing notification to said inventory picker by wirelessly communication a voice command to from said computer system to said wireless headset.

5. The method of claim 1, wherein said alert device further comprises at least one of:
a plurality of light emitting diodes (LED);
a graphical display;
an audio speaker; or
an electric motor adapted for causing said alert device to audibly vibrate.

6. The method of claim 1, comprising the additional steps:
obtaining all inventory items contained in said job order;
placing all inventory items into said storage totes;
confirming that all inventory items have been placed into the correct storage totes; and
packaging said job order for delivery.

7. The method of claim 1, wherein said inventory I.D. numbers are identified by bar codes affixed to said inventory items.

8. The method of claim 1, including the step:
retrofitting an existing inventory management system including an existing inventory database; and
updating said existing inventory database to include the tote I.D. numbers of said storage totes, and the alert I.D. numbers of said alert devices using said identification software.

9. A job order fulfillment system including a host computer system including a CPU, a storage memory, and host software, a known inventory comprising a plurality of unique items identified by inventory I.D. numbers, and a plurality of inventory pickers, the system comprising:
a plurality of storage totes capable of receiving and storing inventory items, each of said storage totes including a bar code comprising a tote I.D. number;
a plurality of RF guns, each said RF gun including a bar code reader capable of identifying picked inventory;
a wireless RF transmitter capable of transmitting notifications from said computer system to said RF guns;
a plurality of alert devices comprising an RF receiver, a control processor, a power supply, and an alert I.D. number, said alert devices being fixedly mounted onto said storage totes and capable of alerting an inventory picker to store an inventory item into the appropriate storage tote;
a job order from a said inventory I.D. numbers;
identification software capable of interfacing with computer system host software, wherein said identification software associates said tote I.D. numbers with said inventory I.D. numbers contained in said job order and said alert I.D. numbers with said tote I.D. numbers;
wherein said job order inventory I.D. numbers are sorted by location; and
wherein said inventory picker is instructed to locate said inventory items from said job order, to place said inventory items into the appropriate storage tote, and to confirm the correct placement of a picked inventory item into a storage tote by scanning both the storage tote and the inventory item using said RF gun, said confirmation being wirelessly transmitted to said computer system via said RF gun transmitter.

10. The system of claim 9, further comprising:
a database stored on the computer system memory, said database containing inventory I.D. numbers, the tote I.D. numbers, and alert I.D. numbers; and
wherein said a job order is created using said database.

11. The system of claim 9, wherein said computer system is capable of notifying said plurality of inventory pickers by wirelessly communicating instructions from said computer system to said RF guns.

12. The system of claim 8, further comprising:
a plurality of wireless headsets provided to each of said inventory pickers, said wireless headsets capable of receiving wireless voice communications;
wherein said computer system is capable of notifying said plurality of inventory pickers by wirelessly communicating voice instructions from said computer system to said wireless headsets.

13. The system of claim 9, wherein said alert device further comprises at least one of:
a plurality of light emitting diodes (LED);
a graphical display;
an audio speaker; or
an electric motor adapted for causing said alert device to audibly vibrate.

14. The system of claim 9, further comprising:
an existing inventory management system including an existing inventory database initially stored on said computer system memory; and
wherein said existing inventory database is updated to include the tote I.D. numbers of said storage totes, and the alert I.D. numbers of said alert devices using said identification software.

15. A method of retrofitting an existing inventory management system including an existing inventory database including a local computer system with host software, a CPU, and storage memory, a known inventory comprising a plurality of unique items identified by inventory I.D. numbers, and a plurality of inventory pickers, the method comprising the steps:
providing a plurality of storage totes capable of receiving and storing inventory items;
providing each said inventory picker with an RF gun including a bar code reader and an RF transmitter, said RF gun capable of identifying picked inventory;
providing identification software capable of interfacing with computer system host software;
providing a wireless RF transmitter capable of transmitting notifications from said computer system to said RF guns;
placing a bar code comprising a tote I.D. number on each of said plurality of totes;
placing a bar code comprising an inventory I.D. number on each of said inventory items;
affixing an alert device onto each of said plurality of storage totes, said alert devices comprising an RF receiver, a control processor, a power supply, an alert I.D. number a plurality of LEDs, a graphical display, and an electric motor capable of causing said alert device to audibly vibrate;
updating the existing database to include the tote I.D. numbers of said storage totes, and the alert I.D. numbers of said alert devices using said identification software;
creating a job order from a list of stored inventory items bar code numbers within said database;
associating said tote I.D. numbers with said inventory I.D. numbers contained in said job order with said identification software and said host software;
associating said alert I.D. numbers with said tote I.D. numbers with said identification software and said host software;
sorting said job order inventory I.D. numbers by location;
wirelessly sending notifications and instructions to said inventory pickers from said computer system to said RF guns via said wireless RF transmitter;
instructing an inventory picker to the location of inventory to be picked via the computer system host software;
instructing an inventory picker to store the picked inventory item into the appropriate storage tote;
confirming that the proper inventory item has been picked up and placed into the proper storage tote by scanning said picked inventory item and said storage tote with said RF gun;
wirelessly transmitting the confirmation to said computer system via said RF gun transmitter;
obtaining all inventory items contained in said job order;
placing all inventory items into said storage totes;
confirming that all inventory items have been placed into the correct storage totes; and
packaging said job order for delivery.
